(19) United States
(12) Patent Application Publication
(10) Pub. No.: US 2014/0368178 A1
(43) Pub. Date: Dec. 18, 2014

(54) VOLTAGE REGULATOR

(71) Applicant: Seiko Instruments Inc., Chiba-shi (JP)

(72) Inventor: Osamu UEHARA, Chiba-shi (JP)

(73) Assignee: Seiko Instruments Inc., Chiba-shi (JP)

(21) Appl. No.: 14/295,001

(22) Filed: Jun. 3, 2014

(30) Foreign Application Priority Data
Jun. 13, 2013 (JP) 2013-124724

(51) Int. Cl. H02M 3/156

(52) U.S. Cl. CPC H02M 3/156
USPC 323/282

(57) ABSTRACT

Provided is a voltage regulator that uses an NMOS transistor as an output transistor and is low in power consumption. The voltage regulator includes an output transistor formed of an NMOS transistor, and a voltage drop circuit connected between a drain of the output transistor and a power supply.

### RELATED APPLICATIONS

This application claims priority under 35 U.S.C. §119 to Japanese Patent Application No. 2013-124724 filed on Jun. 13, 2013, the entire content of which is hereby incorporated by reference.

### BACKGROUND OF THE INVENTION

1. Field of the Invention

The present invention relates to a voltage regulator that uses an NMOS transistor as an output transistor.

2. Description of the Related Art

A related-art voltage regulator is now described. FIG. 6 is a circuit diagram illustrating the related-art voltage regulator.

The related-art voltage regulator includes an error amplifier circuit 103, an amplifier 604, reference voltage circuits 102 and 603, an NMOS transistor 104, resistors 105, 106, 601, and 602, a charge pump 607, capacitors 605 and 606, a power supply terminal 101, a ground terminal 100, and an output terminal 110.

The resistors 105 and 106 are connected in series between the output terminal 110 and the ground terminal 100, and divide an output voltage Vout generated at the output terminal 110. A voltage generated at a node between the resistors 105 and 106 is referred to as a voltage Vfb. When a power supply is turned on, a power supply voltage VDD is generated at the power supply terminal 101 and a voltage Vcp boosted by the charge pump 607 is output from the charge pump 607. When the power supply voltage VDD exceeds a voltage of the reference voltage circuit 603, the amplifier 604 outputs a signal and the error amplifier circuit 103 starts its operation. The error amplifier circuit 103 receives the voltage Vcp boosted by the charge pump 607 as power supply, and outputs to a gate of the NMOS transistor 104 an error voltage between the voltage Vfb and a reference voltage Vref of the reference voltage circuit 102. In this way, the NMOS transistor 104 is controlled so as to output the output voltage Vout from the output terminal 110. Because the error amplifier circuit 103 uses the voltage Vcp boosted by the charge pump 607 as the power supply, the NMOS transistor 104 can be fully turned on, and a voltage close to the voltage of the power supply terminal 101 can be output to the output terminal 110 (see, for example, Japanese Patent Application Laid-open No. 2009-106050).

However, because the related-art voltage regulator uses the output voltage of the charge pump as the power supply of the error amplifier circuit, there is a problem of high power consumption of the charge pump.

### SUMMARY OF THE INVENTION

The present invention has been made in view of the above-mentioned problem, and provides a voltage regulator that uses an NMOS transistor as an output transistor and is low in power consumption.

In order to solve the related-art problem, a voltage regulator according to one embodiment of the present invention has the following configuration.

The voltage regulator includes: an output transistor including an NMOS transistor connected between a power supply terminal and an output terminal; an error amplifier circuit configured to amplify a difference between a reference voltage and a divided voltage obtained by dividing an output voltage output from the output transistor, and output the amplified difference, thereby controlling a gate of the output transistor; and a voltage drop circuit connected between the power supply terminal and a drain of the output transistor.

The voltage regulator according to one embodiment of the present invention, which uses the NMOS transistor as the output transistor, includes the voltage drop circuit connected between the power supply terminal and the drain of the output transistor. Hence, the voltage regulator can control the output transistor without using the charge pump circuit for the power supply of the error amplifier circuit, and can achieve the low power consumption.

### BRIEF DESCRIPTION OF THE DRAWINGS

FIG. 1 is a circuit diagram illustrating a voltage regulator according to one embodiment of the present invention.

FIG. 2 is a circuit diagram illustrating a voltage regulator according to a first embodiment of the present invention.

FIG. 3 is a circuit diagram illustrating a voltage regulator according to a second embodiment of the present invention.

FIG. 4 is a circuit diagram illustrating a voltage regulator according to a third embodiment of the present invention.

FIG. 5 is a circuit diagram illustrating a voltage regulator according to a fourth embodiment of the present invention.

FIG. 6 is a circuit diagram illustrating a related-art voltage regulator.

### DETAILED DESCRIPTION OF THE PREFERRED EMBODIMENTS

In the following, a voltage regulator according to one embodiment of the present invention is described with reference to the drawings.

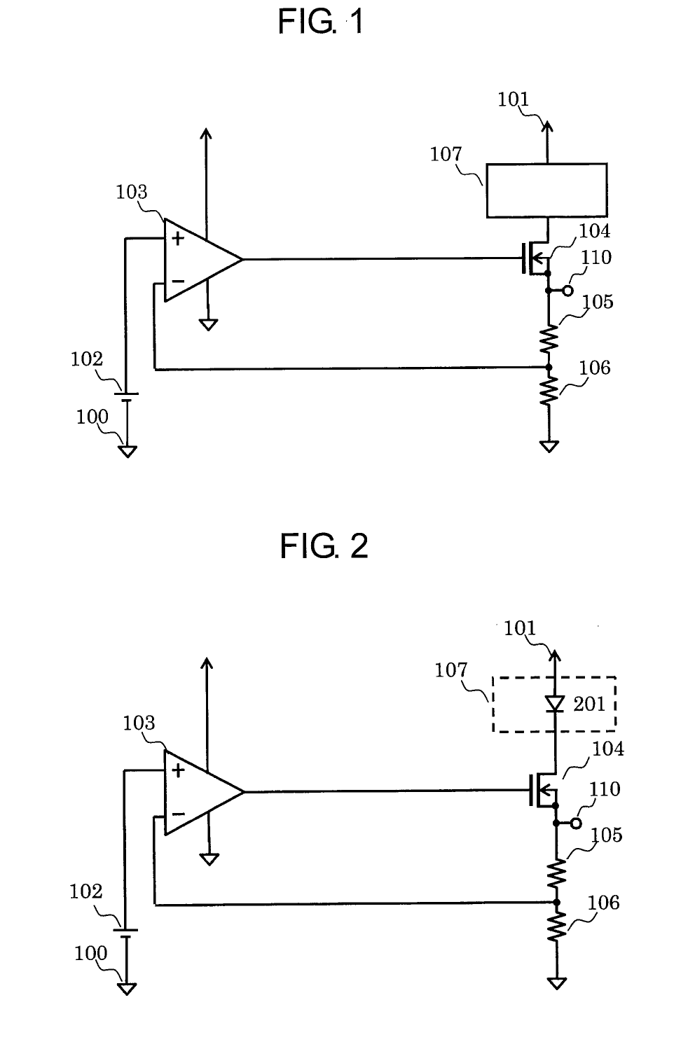

FIG. 1 is a circuit diagram of the voltage regulator according to one embodiment of the present invention.

The voltage regulator of the present invention includes an NMOS transistor 104 as an output transistor, an error amplifier circuit 103, resistors 105 and 106, a reference voltage circuit 102, a ground terminal 100, an output terminal 110, and a power supply terminal 101.

Next, connections in the voltage regulator of the present invention are described.

The error amplifier circuit 103 has a non-inverting input terminal connected to one terminal of the reference voltage circuit 102, and an inverting input terminal connected to a node between the resistors 105 and 106. The NMOS transistor 104 has a gate connected to an output terminal of the error amplifier circuit 103, a source connected to the output terminal 110, and a drain connected to one terminal of a voltage drop circuit 107. The other terminal of the voltage drop circuit 107 is connected to the power supply terminal 101. The resistors 105 and 106 are connected between the output terminal 110 and the ground terminal 100.

Next, operations of the voltage regulator of the present invention are described.

When a power supply voltage VDD is input to the power supply terminal 101, the voltage regulator outputs an output voltage Vout from the output terminal 110. The resistors 105 and 106 divide the output voltage Vout and output a divided voltage Vfb. The error amplifier circuit 103 compares a reference voltage Vref of the reference voltage circuit 102 and the divided voltage Vfb, and controls a gate voltage of the NMOS transistor 104 so that the output voltage Vout is constant.

When the output voltage Vout is higher than a predetermined voltage, the divided voltage Vfb is higher than the reference voltage Vref. Hence, an output signal of the error amplifier circuit 103 (the gate voltage of the NMOS transistor 104) is reduced, and the NMOS transistor 104 is turned off to reduce the output voltage Vout. In addition, when the output voltage Vout is lower than the predetermined voltage, operations opposite to the above-mentioned operations are performed to increase the output voltage Vout. In this way, the voltage regulator operates so that the output voltage Vout is constant.

In this case, the voltage drop circuit 107 outputs, to the drain of the NMOS transistor 104, a voltage VDD-Va that is lower than the power supply voltage VDD by a voltage Va. The voltage of the maximum output of the error amplifier circuit 103 is larger than the output voltage VDD-Va of the voltage drop circuit 107, and hence the error amplifier circuit 103 can fully turn on the NMOS transistor 104. In this way, when the control is performed to increase the low output voltage of the voltage regulator, the error amplifier circuit 103 can control the NMOS transistor to be fully turned on, thereby rapidly increasing the output voltage. In addition, because, unlike the related art, the output of the charge pump circuit is not used for boosting the output voltage of the error amplifier circuit 103 to be higher than the drain voltage of the NMOS transistor 104, a current consumed by the charge pump and an area of the circuit can be reduced.

As described above, the voltage regulator of the present invention includes the NMOS transistor 104 having the drain connected to the voltage drop circuit, and can thus control the NMOS transistor 104 to be fully turned on, thereby rapidly increasing the output voltage. In addition, the low power consumption and the small circuit area can be achieved.

### First Embodiment

FIG. 2 is a circuit diagram of a voltage regulator according to a first embodiment of the present invention. The voltage regulator of the first embodiment includes a diode 201 as the voltage drop circuit 107.

Next, operations of the voltage regulator of the first embodiment are described. When the power supply voltage VDD is input to the power supply terminal 101, the voltage regulator outputs the output voltage Vout from the output terminal 110. The resistors 105 and 106 divide the output voltage Vout and output the divided voltage Vfb. The error amplifier circuit 103 compares the reference voltage Vref of the reference voltage circuit 102 and the divided voltage Vfb, and controls the gate voltage of the NMOS transistor 104 so that the output voltage Vout is constant.

When the output voltage Vout is higher than the predetermined voltage, the divided voltage Vfb is higher than the reference voltage Vref. Hence, the output signal of the error amplifier circuit 103 (the gate voltage of the NMOS transistor 104) is reduced, and the NMOS transistor 104 is turned off to reduce the output voltage Vout. In addition, when the output voltage Vout is lower than the predetermined voltage, the operations opposite to the above-mentioned operations are performed to increase the output voltage Vout. In this way, the voltage regulator operates so that the output voltage Vout is constant.

In this case, a voltage VDD-VF is input to the drain of the NMOS transistor 104, which is lower than the power supply voltage VDD by a forward voltage VF of the diode 201. The voltage of the maximum output of the error amplifier circuit 103 is larger than the output voltage VDD-VF of the voltage drop circuit 107, and hence the error amplifier circuit 103 can fully turn on the NMOS transistor 104. In this way, when the control is performed to increase the low output voltage of the voltage regulator, the error amplifier circuit 103 can control the NMOS transistor to be fully turned on, thereby rapidly increasing the output voltage. In addition, because, unlike the related art, the output of the charge pump circuit is not used for boosting the output voltage of the error amplifier circuit 103 to be higher than the drain voltage of the NMOS transistor 104, the current consumed by the charge pump and the area of the circuit can be reduced.

As described above, the voltage regulator of the first embodiment includes the NMOS transistor 104 having the drain connected to the voltage drop circuit, and can thus control the NMOS transistor 104 to be fully turned on, thereby rapidly increasing the output voltage. In addition, the low power consumption and the small circuit area can be achieved.

### Second Embodiment

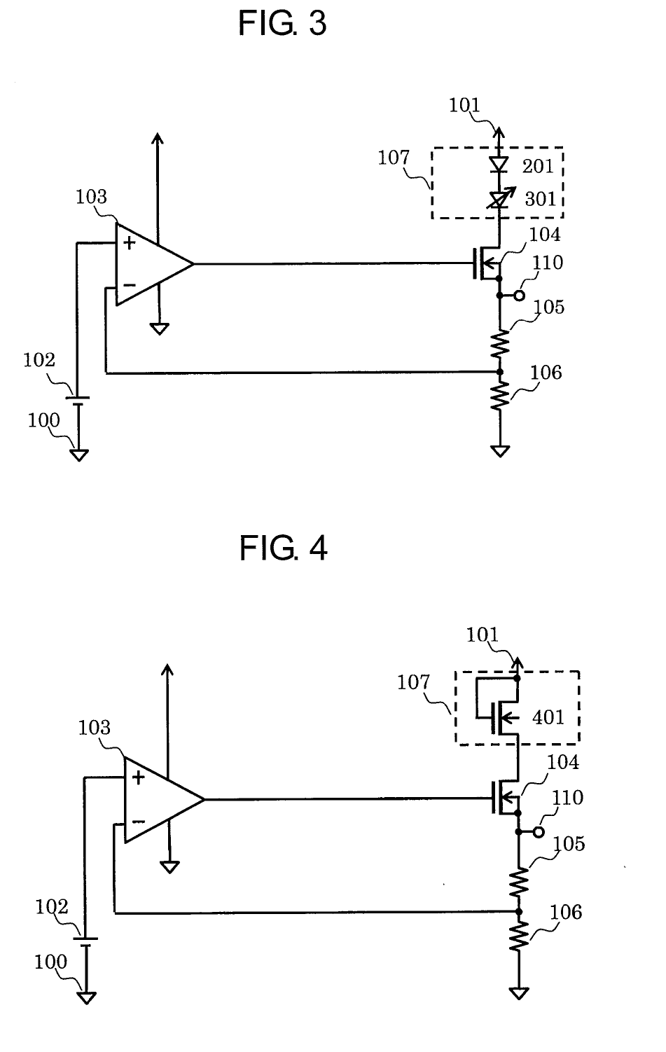

FIG. 3 is a circuit diagram of a voltage regulator according to a second embodiment of the present invention. The voltage regulator of the second embodiment includes the diode 201 and a diode 301 as the voltage drop circuit 107.

Next, operations of the voltage regulator of the second embodiment are described. The same operations are performed in the voltage regulator of the second embodiment as in the first embodiment, and hence a description thereof is omitted. The diode 301 can adjust the number of diodes connected in series to the NMOS transistor 104, and hence the diode 301 can adjust the drain voltage of the NMOS transistor 104. For this reason, a transistor having a low drain breakdown voltage can be used as the NMOS transistor 104.

As described above, the voltage regulator of the second embodiment includes the NMOS transistor 104 having the drain connected to the diodes, and can thus control the NMOS transistor 104 to be fully turned on, thereby rapidly increasing the output voltage. In addition, the low power consumption and the small circuit area can be achieved. Besides, the drain voltage of the NMOS transistor 104 can further be reduced by adjusting the number of the diodes, and hence a transistor having a low drain breakdown voltage can be used as the NMOS transistor 104.

### Third Embodiment

FIG. 4 is a circuit diagram of a voltage regulator according to a third embodiment of the present invention. The voltage regulator of the third embodiment includes an NMOS transistor 401 having a gate and a drain connected to the power supply terminal 101 as the voltage drop circuit 107. The same operations are performed in the voltage regulator of the third embodiment as in the first embodiment, and hence a description thereof is omitted. Also with this configuration, the drain voltage of the NMOS transistor 104 can be dropped. Then, the control can be performed so that the NMOS transistor 104 is fully turned on to rapidly increase the output voltage.

As described above, the voltage regulator of the third embodiment includes the NMOS transistor 104 having the drain connected to the NMOS transistor 401 having the gate and the drain connected to each other, and can thus control the NMOS transistor 104 to be fully turned on, thereby rapidly increasing the output voltage. In addition, the low power consumption and the small circuit area can be achieved.

### Fourth Embodiment

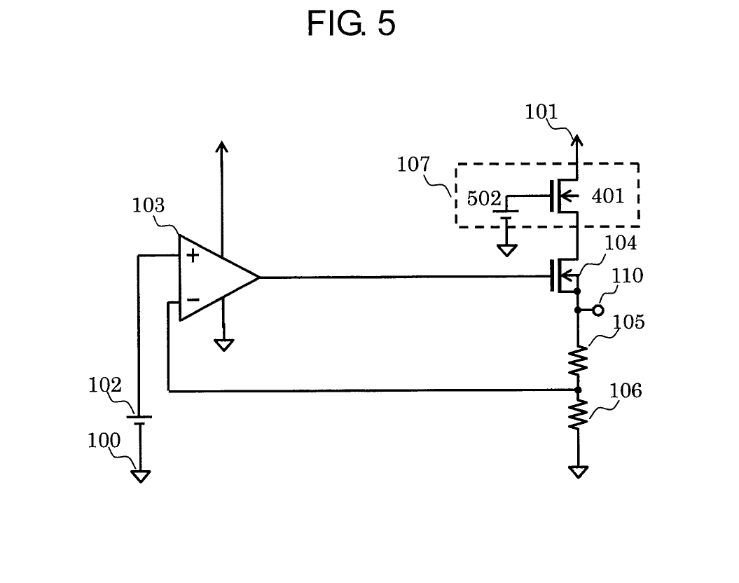

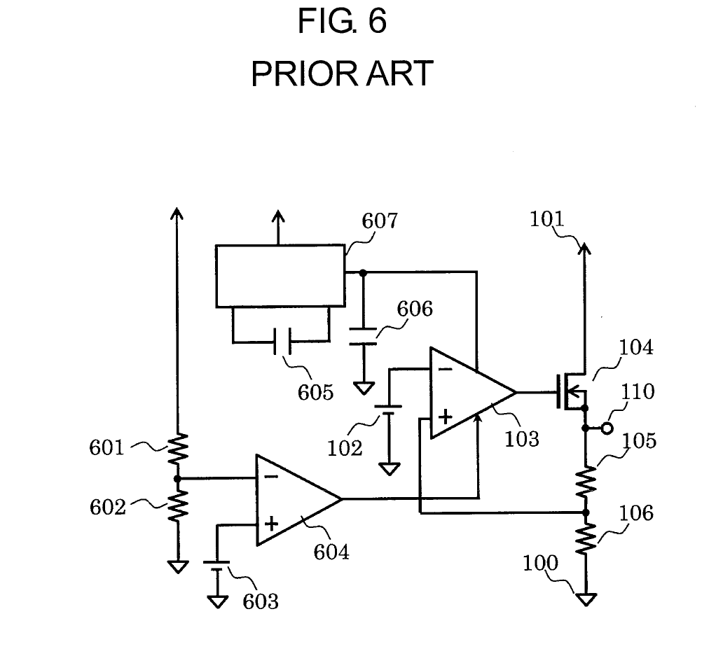

FIG. 5 is a circuit diagram of a voltage regulator according to a fourth embodiment of the present invention. The voltage regulator of the fourth embodiment includes an NMOS transistor 401 having a gate connected to a constant voltage circuit 502 as the voltage drop circuit 107. The same operations are performed in the voltage regulator of the fourth embodiment as in the third embodiment. With this configuration, the drain voltage of the NMOS transistor 104 can be adjusted by a voltage of the constant voltage circuit 502, and hence a transistor having a low drain breakdown voltage can be used as the NMOS transistor 104.

As described above, the voltage regulator of the fourth embodiment includes the NMOS transistor 104 having the drain connected to the NMOS transistor 401 having the gate connected to the constant voltage circuit 502, and can thus control the NMOS transistor 104 to be fully turned on, thereby rapidly increasing the output voltage. In addition, the low power consumption and the small circuit area can be achieved. Besides, the drain voltage of the NMOS transistor 104 can further be reduced by adjusting the voltage of the constant voltage circuit 502, and hence a transistor having a low drain breakdown voltage can be used as the NMOS transistor 104.

What is claimed is:

1. A voltage regulator, comprising:
an output transistor comprising an NMOS transistor connected between a power supply terminal and an output terminal;
an error amplifier circuit configured to amplify a difference between a reference voltage and a divided voltage obtained by dividing an output voltage output from the output transistor, and output the amplified difference, thereby controlling a gate of the output transistor; and
a voltage drop circuit connected between the power supply terminal and a drain of the output transistor.

2. A voltage regulator according to claim 1, wherein the voltage drop circuit comprises a diode including an anode connected to the power supply terminal, and a cathode connected to the drain of the output transistor.

3. A voltage regulator according to claim 1, wherein the voltage drop circuit comprises an NMOS transistor including a gate and a drain connected to the power supply terminal, and a source connected to the drain of the output transistor.

4. A voltage regulator according to claim 1, wherein the voltage drop circuit comprises an NMOS transistor including a gate connected to a constant voltage circuit, a drain connected to the power supply terminal, and a source connected to the drain of the output transistor.
